(19) United States
(12) Patent Application Publication
(10) Pub. No.: US 2009/0044555 A1
(43) Pub. Date: Feb. 19, 2009

(54) Desiccant dehumidifier

(75) Inventor: Seung-tae Park, Seongnam-si (KR)

Correspondence Address: Ballard Spahr Andrews & Ingersoll, LLP, SUITE 1000, 999 PEACHTREE STREET, ATLANTA, GA, 30309-3915, US

(73) Assignee: Air-Tech Engineering Co., Lte., Seongnam-si (KR)

(21) Appl. No.: 12/001,002

(22) Filed: Dec. 7, 2007

(30) Foreign Application Priority Data
Aug. 13, 2007 (KR) 10-2007-0081178

(51) Int. Cl. B01D 53/14; F25D 23/00

(52) U.S. Cl. 62/271

(57) ABSTRACT

Provided is a desiccant dehumidifier characterized in that: external air is introduced through a cooling coil and an eliminator; the introduced external air is bifurcated into a desiccant rotor and a bypass line in front of the desiccant rotor; the external air bifurcated to the desiccant rotor passes through the desiccant rotor disposed at a dehumidifying section to perform dehumidification, and the bypass air passed through the bypass line is mixed with the air passed through the desiccant rotor behind the desiccant rotor to form suction air to be supplied through a suction fan; and a part of the external air bifurcated to the desiccant rotor passes through the desiccant rotor disposed at a purge section, and then passes through the desiccant rotor disposed at a recycling section via a recycling heater to form exhaust air to be exhausted through an exhaust fan, wherein ventilation air is introduced through a separate path on a path through which the external air is introduced and then mixed with the external air.

Therefore, the bypass line is installed to bypass the desiccant rotor during an external air dehumidification process so that the bypass air passed through the bypass line is mixed with the suction air dehumidified through the desiccant rotor and the internal air is mixed with the external air to improve quality of the internal air.

### CROSS-REFERENCE TO RELATED APPLICATION

This application claims the benefit of Korean Patent Application No. 10-2007-0081178, filed on Aug. 13, 2007, the disclosure of which is hereby incorporated herein by reference in its entirety.

### BACKGROUND OF THE INVENTION

1. Field of the Invention

The present invention relates to a desiccant dehumidifier, and more particularly, to a desiccant dehumidifier capable of lowering a temperature of supplied air using bypass air and of dehumidifying the interior mixing vent air in the interior with external air.

2. Description of the Prior Art

In general, a desiccant dehumidifier is an apparatus for sucking moist air to pass through a heat exchanger including a condenser and an evaporator through which a refrigerant flows, or a desiccant to lower humidity of the supplied air, and supplying the dehumidified air into the interior to lower humidity in the interior.

An example of a conventional desiccant dehumidifier is disclosed in Korean Utility Model Registration No. 323078, issued on Aug. 1, 2003 (hereinafter, referred to as “conventional art”).

As shown in FIG. 1, the technology disclosed in the conventional art includes a suction fan 23 driven to pass external air i through a dehumidifying rotor 21 disposed at a suction airflow section 21a to humidify the external air such that a suction airflow g is formed to supply the dehumidified suction air j into the interior, an exhaust fan 25 driven to heat the recycling external air using a rotor recycling heater 29 and then pass the external air i through the dehumidifying rotor 21 disposed at an exhaust airflow section 21b to dehumidify the external air i such that an exhaust airflow h is formed in a reverse direction of the suction airflow g to remove and discharge the absorbed moisture, and a motor 35 driven to rotate the dehumidifying rotor 21 in a direction c from the suction airflow section 21a to the discharge airflow section 21b. For this purpose, a driven sprocket (not shown) having a predetermined pitch is installed at an outer periphery of the dehumidifying rotor 21, and the driven sprocket is connected to a driving sprocket 41 adjacent to the motor 35 through a chain 39. Meanwhile, reference numeral 27 designates a pre-filter, reference numeral 30 designates a partition wall, reference character k designates a high temperature and humidified air, reference character 1 designates a purge flow, and reference character ii designates purge air.

### SUMMARY OF THE INVENTION

Since the conventional art dehumidifies external air only to deteriorate quality of the internal air, a separate ventilation or exhaust device is needed. In addition, it is difficult to lower a temperature of suction air supplied into the interior.

An object of the present invention is to provide a desiccant dehumidifier capable of lowering a temperature of suction air by installing a bypass line for bypassing a desiccant rotor, and of improving the quality of the internal air by mixing the internal air with the external air for dehumidifying.

An aspect of the present invention provides a desiccant dehumidifier characterized in that: external air is introduced through a cooling coil and an eliminator; the introduced external air is bifurcated into a desiccant rotor and a bypass line in front of the desiccant rotor; the external air bifurcated to the desiccant rotor passes through the desiccant rotor disposed at a dehumidifying section to perform dehumidification, and the bypass air passed through the bypass line is mixed with the air passed through the desiccant rotor behind the desiccant rotor to form suction air to be supplied through a suction fan; and a part of the external air bifurcated to the desiccant rotor passes through the desiccant rotor disposed at a purge section, and then passes through the desiccant rotor disposed at a recycling section via a recycling heater to form exhaust air to be exhausted through an exhaust fan, wherein ventilation air is introduced through a separate path on a path through which the external air is introduced and then mixed with the external air.

In addition, the cooling coil may include: a first cooling coil and a second cooling coil; and the ventilation air may be introduced through a separate path formed at an airflow path between the first cooling coil and the second cooling coil to be mixed with the external air.

Another aspect of the present invention provides a desiccant dehumidifier characterized in that: external air is introduced through a cooling coil and an eliminator; the introduced external air is bifurcated into a desiccant rotor and a bypass line in front of the desiccant rotor; the external air bifurcated to the desiccant rotor passes through the desiccant rotor disposed at a dehumidifying section to perform dehumidification, and the bypass air passed through the bypass line is mixed with the air passed through the desiccant rotor behind the desiccant rotor to form suction air to be supplied through a suction fan; and a part of the external air bifurcated to the desiccant rotor passes through the desiccant rotor disposed at a purge section, and then passes through the desiccant rotor disposed at a recycling section via a recycling heater to form exhaust air to be exhausted through an exhaust fan, wherein ventilation air is introduced through a separate path formed at the bypass line to be mixed with the external air bifurcated to the bypass line, and the bypass line and airflow path bifurcated into the desiccant rotor are connected to each other by a connection damper.

In addition, an air filter may be further installed in front of the cooling coil, and the ventilation air may pass through the air filter and the cooling coil and may then be mixed with the external air.

Further, a dehumidifier treatment fan may be further installed in front of the desiccant rotor, and the external air may be introduced into the desiccant rotor disposed at the dehumidifying section and the purge section through the dehumidifier treatment fan.

Furthermore, a bypass heater may be installed at the bypass line, and a suction air heater may be installed at a discharge port of the suction fan.

In addition, a humidifier may be further installed at the bypass line.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a conventional desiccant dehumidifier;

FIG. 2 illustrates a desiccant dehumidifier in accordance with a first exemplary embodiment of the present invention;

FIG. 3 illustrates a dehumidifier treatment fan installed in the first exemplary embodiment of the present invention;

FIG. 4 illustrates a heater installed in the first exemplary embodiment of the present invention;

FIG. 5 illustrates a humidifier further installed in the first exemplary embodiment of the present invention;

FIG. 6 illustrates a desiccant dehumidifier in accordance with a second exemplary embodiment of the present invention;

FIG. 7 illustrates a heater installed in the second exemplary embodiment of the present invention;

FIG. 8 illustrates a desiccant dehumidifier in accordance with a third exemplary embodiment of the present invention;

FIG. 9 illustrates a single cooling coil installed in the third exemplary embodiment of the present invention;

FIG. 10 illustrates a heater and a humidifier installed in the third exemplary embodiment of the present invention; and

FIG. 11 illustrates a single cooling coil installed in FIG. 10.

### DETAILED DESCRIPTION OF EXEMPLARY EMBODIMENTS

Hereinafter, exemplary embodiments of the present invention will be described with reference to the accompanying drawings. Like reference numerals designate like elements throughout the specification, and descriptions thereof will not be repeated.

### First Embodiment

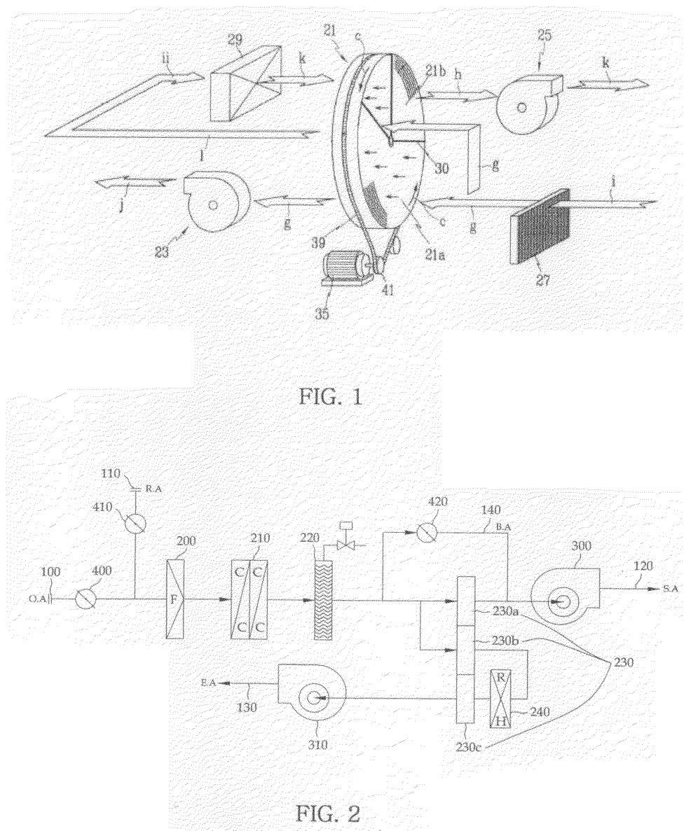

As shown in FIG. 2, a desiccant dehumidifier in accordance with a first exemplary embodiment of the present invention includes an external air damper 400 for introducing external air 100 and controlling an amount of the external air, a ventilation damper 410 introducing ventilation air 110 entering from the interior and controlling an amount of the ventilation air, an air filter 200, a cooling coil 210, an eliminator 220, a desiccant rotor 230 accommodating a dehumidifying section 230a, a purge section 230b and a recycling section 230c, a suction fan 300, and an exhaust fan 310.

Specifically, the external air 100 introduced from the exterior into the desiccant dehumidifier may be introduced, blocked or quantitatively adjusted through the external air damper 400, and the ventilation air 110 introduced from the interior may be introduced, blocked or quantitatively adjusted through the ventilation damper 410.

The external air 100 and the ventilation air 110 introduced as described above are mixed with each other to pass through the air filter 200 installed behind the external air damper 400 to filter dusts mixed with the air.

In addition, at least one cooling coil 210 is installed behind the air filter 200 to improve cooling capacity, and the eliminator 220 is installed behind the cooling coil 210 to dehumidify the external air 100.

At this time, the number and the kind of the cooling coils may be selectively used according to an amount of cooled and dehumidified air.

In addition, in order to prevent humidity in the interior from being excessively lowered when external humidity is low, a water supply device is connected to the eliminator 220 to humidify the interior. Further, when air pollution is a problem, water supply into the eliminator can filter dusts from the air, and so on.

Furthermore, the desiccant rotor 230 is disposed behind the eliminator 220, the air passed through the eliminator 220 is bifurcated into the desiccant rotor 230 and the bypass line, and the air introduced into the desiccant rotor 230 is bifurcated again into the dehumidifying section 230a and the purge section 230b.

Here, when an area ratio of the dehumidifying section 230a to the purge section 230b and to the recycling section 230c is 2˜4:1:1, capacity of a recycling heater 240 may be reduced.

The bypass line is bifurcated behind the eliminator 220 to be connected to a front end of the suction fan 300. At this time, a bypass air 140 passing through the bypass line does not pass through the desiccant rotor 230. In addition, a bypass damper 420 may be installed at the bypass line to adjust airflow of the bypass line.

Further, the air passed through the desiccant rotor 230 disposed at the dehumidifying section 230a is mixed with the bypass air 140 to be supplied into the interior through the suction fan 300 as suction air 120.

Furthermore, the air passed through the desiccant rotor 230 disposed at the purge section 230b moves toward the desiccant rotor 230 disposed at the recycling section 230c, and the recycling heater 240 is installed on an airflow path between the purge section 230b and the recycling section 230c. Exhaust air 130 passed through the desiccant rotor 230 disposed at the recycling section 230c is exhausted to the exterior through the exhaust fan 310.

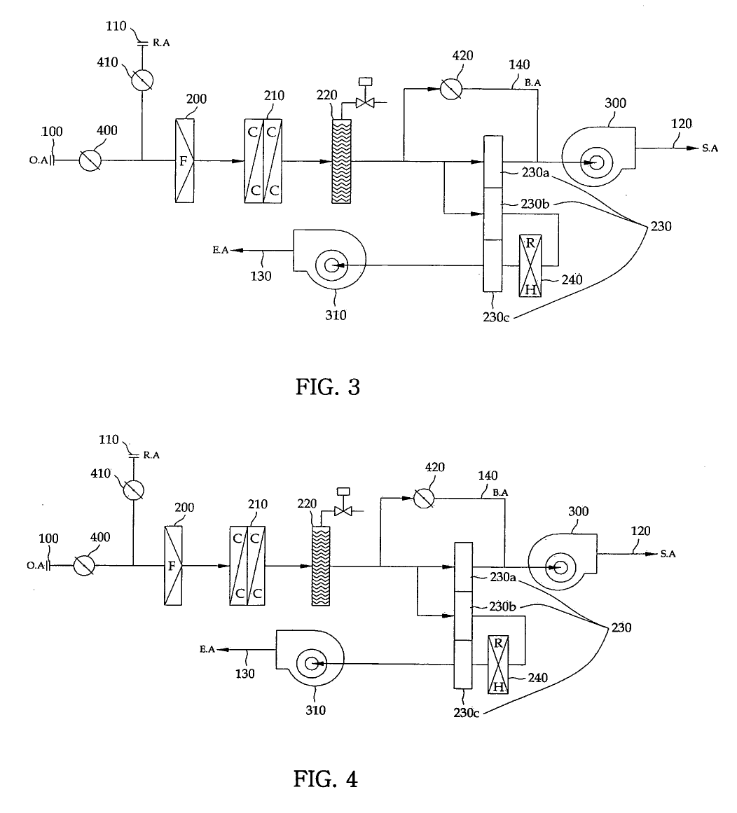

As shown in FIG. 3, in order to disperse a humidifier constant pressure and reduce load on the suction fan 300 and the exhaust fan 310, a humidifier treatment fan 320 may be further installed in front of the desiccant rotor 230 to reduce noise generation. In this case, the desiccant dehumidifier can be used in the interior.

Meanwhile, as shown in FIG. 4, in order to use the desiccant dehumidifier when humidity is very low, a bypass heater 250 is installed at the bypass line of the desiccant dehumidifier, and a suction air heater 260 may be installed at a discharge port of the suction fan 300, if necessary.

At this time, a treatment damper 430 is installed in front of the desiccant rotor 230 to adjust an amount of air moving to the desiccant rotor 230, and the treatment damper 430 may be installed to be linked to the bypass damper 420 and operated therewith.

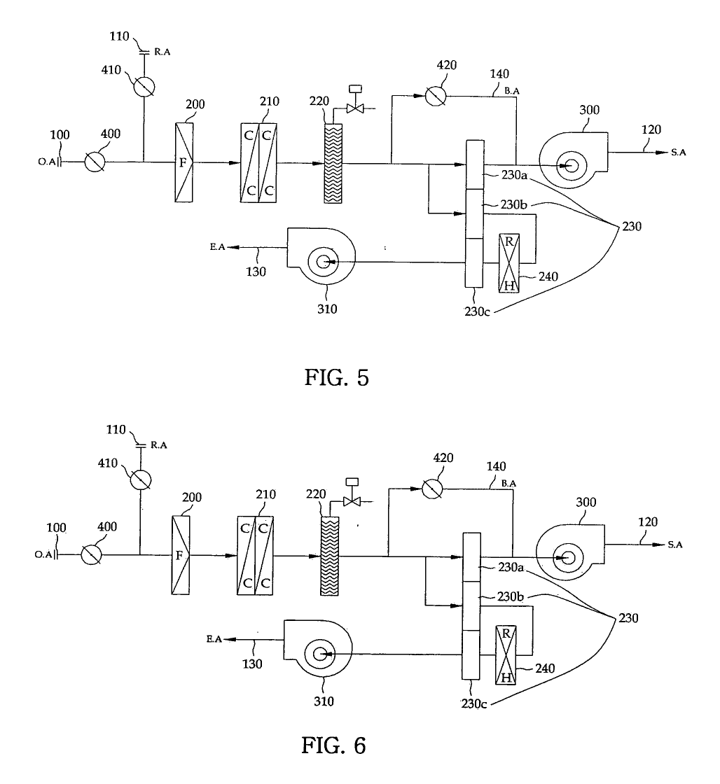

In addition, as shown in FIG. 5, although there is a need to maintain the same humidity throughout the year, humidity in the interior may be excessively lowered due to a low external humidity. In order to prevent the humidity in the interior from being excessively lowered, a humidifier 270 may be further installed at the bypass line to provide the same humidity throughout the year.

Hereinafter, operation of the desiccant dehumidifier in accordance with a first exemplary embodiment of the present invention will be described.

First, the external air damper 400 and the ventilation damper 410 are opened by a start switch (not shown) of the desiccant dehumidifier, and the suction fan 300 and the exhaust fan 310 are operated to rotate the desiccant rotor 230.

Next, the external air 100 is introduced through the opened external air damper 400, the ventilation air 110 is introduced through the ventilation damper 410, and the external air 100 and the ventilation air 110 are mixed with each other to pass through the air filter 200 and then pass through the cooling coil 210 such that the air is maximally cooled to 7° C.-15° C. to pass through the eliminator 220.

In addition, the air passed through the eliminator 220 is bifurcated into the desiccant rotor 230 and the bypass line, and the air directed to the desiccant rotor 230 is bifurcated again into the dehumidifying section 230a and the purge section 230b.

Here, in order to disperse the dehumidifier constant pressure and reduce load on the suction fan 300 and the exhaust fan 310, the dehumidifier treatment fan 320 is further installed in front of the desiccant rotor 230 to reduce noise generation. In this case, the desiccant dehumidifier can also be used in the interior (see FIGS. 3 and 5).

At this time, the air bifurcated to the desiccant rotor 230 and the air bifurcated to the bypass line may be quantitatively adjusted by the treatment damper 430 and the bypass damper 420, respectively.

Here, the air passed through the desiccant rotor 230 disposed at the dehumidifying section 230a and having a normal temperature and low humidity is mixed with the bypass air 140 passed through the bypass line to form the suction air 120 having a required temperature and humidity to be supplied into the interior through the suction fan 300.

In addition, the air passed through the desiccant rotor 230 disposed at the purge section 230b passes through the recycling heater 240 and is heated to a high temperature, and then, passes through the desiccant rotor 230 disposed at the recycling section 230c. After removing moisture dehumidified through the desiccant rotor 230, the air becomes the exhaust air 130 to be exhausted through the exhaust fan 310.

When the desiccant dehumidifier in accordance with the present invention is used when an external temperature is very low, the bypass heater 250 and the suction air heater 260 are installed behind the bypass line and the suction fan 300 to increase a temperature of the suction air 120 and supply a high temperature air into the interior, thereby heating the interior (see FIGS. 4 and 5).

At this time, the suction air heater 260 may be selectively used according to a temperature required by the suction air 120 supplied into the interior.

### Second Embodiment

Hereinafter, another embodiment in accordance with the present invention will be described with reference to FIG. 6.

A desiccant dehumidifier in accordance with a second exemplary embodiment of the present invention uses two cooling coils 210 to increase dehumidifying efficiency of external air 100, dissimilar to the first embodiment.

In this case, the external air 100 is introduced to pass through a first air filter 200 and then is cooled by a first cooling coil 210a, and ventilation air 110 passes through a second air filter 200′ and then is mixed with the external air 100 passed through the first cooling coil 210a to pass through a second cooling coil 210b.

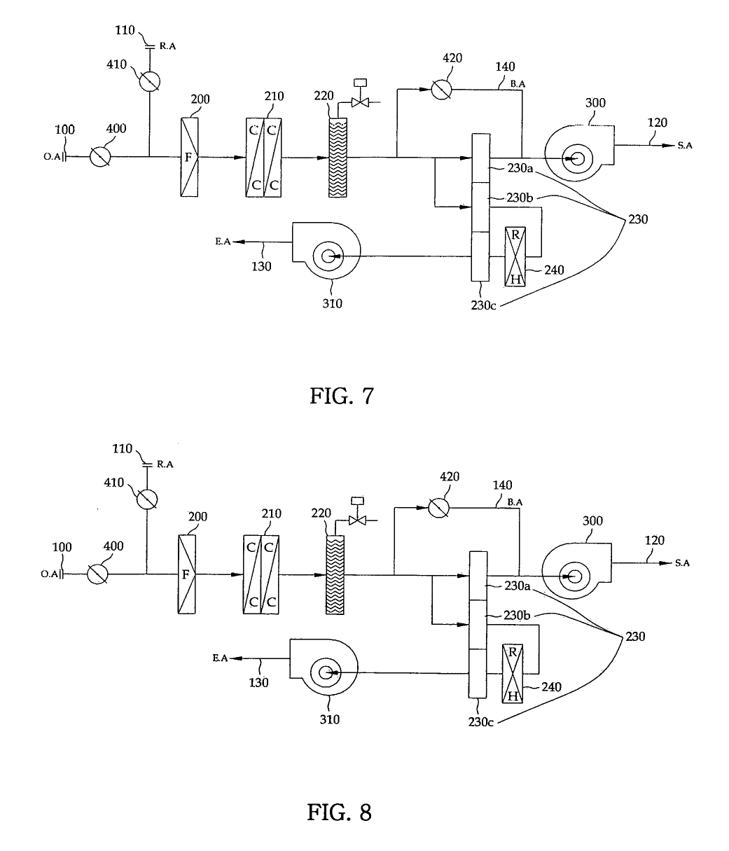

In addition, as shown in FIG. 7, similar to the case of FIG. 4 described to perform heating when an external temperature is very low, a bypass heater 250 is installed at a bypass line, and a suction air heater 260 may be installed at a discharge port of a suction fan 300 depending on necessity.

### Third Embodiment

Hereinafter, another embodiment in accordance with an exemplary embodiment of the present invention will be described with reference to FIG. 8.

A desiccant dehumidifier in accordance with a third exemplary embodiment of the present invention is provided to be readily used when external humidity is high. Dissimilar to the second embodiment, ventilation air 110 is separated from external air 100 such that the external air 100 and the ventilation air 110 pass through separate air filters 200 and 200′ and cooling coils 210a and 210b, are separately cooled, and are then mixed with each other.

That is, when the ventilation air 110 has humidity significantly different from the external air 100, since a humidifying load is increased when the external air 100 is not cooled separately from the ventilation air 110, the external air 100 and the ventilation air 110 are cooled and then mixed with each other to pass through the desiccant rotor 230 disposed at the dehumidifying section 230a and the purge section 230b.

At this time, the ventilation air 110 is connected to the bypass line, and the external air 100 passed through the first air filter 200, the first cooling coil 210a, and the eliminator 220 may be mixed with the ventilation air 110 passed through the second air filter 200 and the second cooling coil 210b through a connection damper 440.

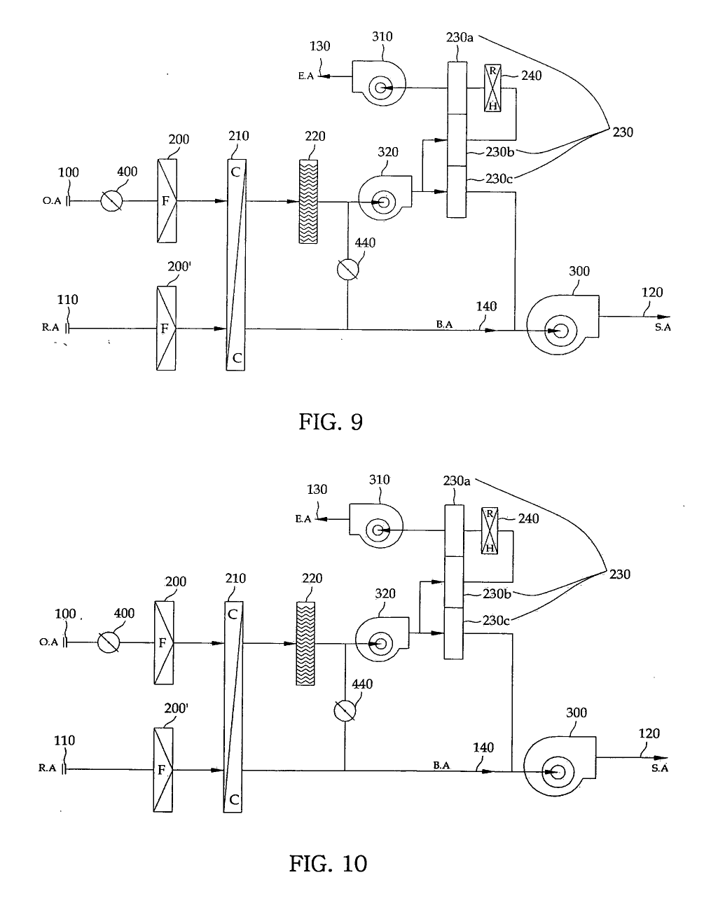

Meanwhile, as shown in FIG. 9, in the desiccant dehumidifier of the third embodiment, the external air 100 and the ventilation air 110 may pass through a single cooling coil 210 in a non-mixed state to be cooled, thereby reducing manufacturing cost and simplifying internal structure thereof.

In addition, as shown in FIG. 10, in order to heat the interior for the purpose of year-round use, a bypass heater 250 is further installed at a bypass line, and a suction air heater 260 may be installed at a discharge port of a suction fan 300 depending on necessity.

Further, when the same humidity should be provided, in order to prevent humidity in the interior from being excessively lowered due to low external humidity, a humidifier 270 may be further installed at a bypass line to provide the same humidity throughout the year.

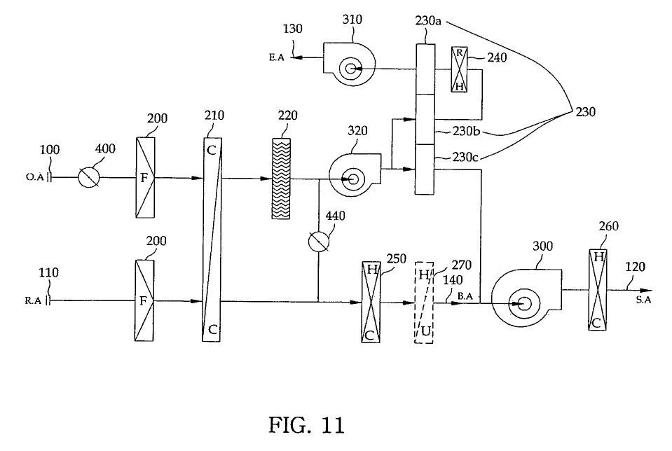

Meanwhile, as shown in FIG. 11, only one cooling coil 210 may be installed at a desiccant dehumidifier to cool external air 100 and ventilation air 110.

In accordance with a desiccant dehumidifier of the present invention, a bypass line is installed to bypass a desiccant rotor during an external air dehumidification process so that the bypass air passed through the bypass line is mixed with the suction air dehumidified through the desiccant rotor and the internal air is mixed with the external air to improve quality of the internal air.

In addition, in accordance with the desiccant dehumidifier of the present invention, a dehumidifier treatment fan is installed in front of the desiccant rotor to appropriately adjust an amount of air and reduce load on a suction fan and a recycling fan, thereby reducing noise generation.

Further, in accordance with the desiccant dehumidifier of the present invention, a heater or a-humidifier is installed on an airflow path to appropriately increase the temperature and humidity of the suction air when necessary, and supply the same into the interior.

While this invention has been described with reference to exemplary embodiments thereof, it will be clear to those of ordinary skill in the art to which the invention pertains that various modifications may be made to the described embodiments without departing from the spirit and scope of the invention as defined in the appended claims and their equivalents.

What is claimed is:

1. A desiccant dehumidifier characterized in that:
external air is introduced through a cooling coil and an eliminator;
the introduced external air is bifurcated into a desiccant rotor and a bypass line in front of the desiccant rotor;
the external air bifurcated to the desiccant rotor passes through the desiccant rotor disposed at a dehumidifying section to perform dehumidification, and the bypass air passed through the bypass line is mixed with the air passed through the desiccant rotor behind the desiccant rotor to form suction air to be supplied through a suction fan; and
a part of the external air bifurcated to the desiccant rotor passes through the desiccant rotor disposed at a purge section, and then passes through the desiccant rotor disposed at a recycling section via a recycling heater to form exhaust air to be exhausted through an exhaust fan,
wherein ventilation air is introduced through a separate path on a path through which the external air is introduced and then mixed with the external air.

2. The desiccant dehumidifier according to claim 1, wherein the cooling coil comprises a first cooling coil and a second cooling coil, and the ventilation air is introduced through the separate path formed on an airflow path between the first cooling coil and the second cooling coil to be mixed with the external air.

3. A desiccant dehumidifier characterized in that:
external air is introduced through a cooling coil and an eliminator;
the introduced external air is bifurcated into a desiccant rotor and a bypass line in front of the desiccant rotor;
the external air bifurcated to the desiccant rotor passes through the desiccant rotor disposed at a dehumidifying section to perform dehumidification, and the bypass air passed through the bypass line is mixed with the air passed through the desiccant rotor behind the desiccant rotor to form suction air to be supplied through a suction fan; and
a part of the external air bifurcated to the desiccant rotor passes through the desiccant rotor disposed at a purge section, and then passes though the desiccant rotor disposed at a recycling section via a recycling heater to form exhaust air to be exhausted through an exhaust fan,
wherein ventilation air is introduced through a separate path formed at the bypass line to be mixed with the external air bifurcated to the bypass line, and
the bypass line and airflow path bifurcated into the desiccant rotor are connected to each other by a connection damper.

4. The desiccant dehumidifier according to claim 3, wherein an air filter is further installed in front of the cooling coil, and the ventilation air passes through the air filter and the cooling coil and then is mixed with the external air.

5. The desiccant dehumidifier according to any one of claims 1, wherein a dehumidifier treatment fan is further installed in front of the desiccant rotor, and the external air is introduced into the desiccant rotor disposed at the dehumidifying section and the purge section through the dehumidifier treatment fan.

6. The desiccant dehumidifier according to any one of claims 3, wherein a dehumidifier treatment fan is further installed in front of the desiccant rotor, and the external air is introduced into the desiccant rotor disposed at the dehumidifying section and the purge section through the dehumidifier treatment fan.

7. The desiccant dehumidifier according to any one of claims 1, wherein a bypass heater is installed at the bypass line, and a suction air heater is installed at a discharge port of the suction fan.

8. The desiccant dehumidifier according to any one of claims 3, wherein a bypass heater is installed at the bypass line, and a suction air heater is installed at a discharge port of the suction fan.

9. The desiccant dehumidifier according to claim 7, wherein a humidifier is further installed at the bypass line.

10. The desiccant dehumidifier according to claim 8, wherein a humidifier is further installed at the bypass line.
